(19) United States
(12) Patent Application Publication
(10) Pub. No.: US 2026/0331316 A1
(43) Pub. Date: Oct. 22, 2026

(54) BALL-DETENT MECHANICAL HOLD DOWN FOR NUCLEAR REACTOR CORE ASSEMBLIES

(71) Applicant: TerraPower, LLC, Bellevue, WA (US)

(72) Inventor: Jeffrey R. Rudd, Cape Coral, FL (US)

(21) Appl. No.: 19/249,561

(22) Filed: Jun. 25, 2025

Related U.S. Application Data
(60) Provisional application No. 63/687,263, filed on Aug. 26, 2024.

(51) Int. Cl. G21C 5/10; G21C 13/024; G21C 13/032

(52) U.S. Cl. CPC G21C 5/10; G21C 13/024; G21C 13/032

(57) ABSTRACT

A nuclear reactor is designed and constructed to withstand seismic events. A mechanical hold down system may be provided as cooperating structure between the core receptacle and a nozzle of a core assembly. One or more ball detent features may be configured to provide a mechanical hold down force of the core assembly into the receptacle. As the nozzle is inserted into the receptacle, the ball lock carried by the core assembly snaps into the detent within the receiver to inhibit unintentional withdrawal of the nozzle from the receiver. The insertion force and the retention force may be varied and may be asymmetrical based upon the specific geometries of the receptacle, the detent, and a spring force that biases the ball locks outwardly from the nozzle.

### CROSS REFERENCE

The present application claim benefit of priority to U.S. Provisional Patent Application No. 63/687,263, filed Aug. 26, 2024, titled “BALL-DETENT MECHANICAL HOLD DOWN FOR NUCLEAR REACTOR CORE ASSEMBLIES,” the entire contents of which is hereby incorporated by reference.

### GOVERNMENT LICENSE RIGHTS

This invention was made with government support under DOE Cooperative Agreement No. DE-NE0009054 awarded by the U.S. Department of Energy. The government has certain rights in the invention.

### FIELD OF THE DISCLOSURE

This disclosure is directed to a secondary mechanical hold down system for nuclear core assemblies.

### BACKGROUND

In a sodium-cooled fast reactor (“SFR”), the main reactor components are a reactor vessel filled with a liquid sodium coolant and a reactor core. In some cases, an SFR includes core assemblies within the core, some of which contain fissile nuclear fuel. Once the fission chain reaction is initiated, heat builds within the nuclear reactor core. The reactor core is immersed in a pool of sodium coolant in the reactor vessel which draws the heat away from the reactor core.

The sodium coolant flows through the core assemblies, some of which may be fuel assemblies, by entering a nozzle of the core assembly and flowing about the fuel pins within the core assemblies to remove heat therefrom. A containment vessel surrounds the reactor vessel to prevent loss of sodium coolant in case of an unlikely leak from the reactor vessel. The pumps circulate primary sodium coolant between the reactor core and intermediate heat exchangers located in the pool. These heat exchangers may have non-radioactive intermediate sodium coolant on the other side of the heat exchanger. Heated intermediate sodium coolant may be circulated to a thermal storage system or directly to steam generators that generate steam to drive turbines of electrical generators.

The reactor core may contain several types of core assemblies, including core assemblies containing fissile fuel, fertile fuel, reflectors, neutron absorbers, among others. The forces of the flowing sodium on the core assemblies typically imparts an upward force on the core assemblies that tends to lift the core assemblies from their mounting sockets. In some cases, the pressure differential on the core assemblies from the flowing sodium imparts sufficient lifting force on the core assemblies that one or more core assemblies may lift out of the mounting receptacle. If a core assembly lifts out of its socket, a cascade of events is likely to occur, which may even include the loss of control of the nuclear reaction. For instance, the assembly can be starved of coolant, which can increase the temperature of the assembly rapidly.

In some SFR nuclear reactor designs, an upper hold down is provided to constrain the core assemblies from lifting out of their receptacles. However, an upper constraint adds complexity and, by fixing an upper limit of the core assemblies, invites the core assemblies to bow in response to thermal stresses. Moreover, the core assemblies are formed to have the same geometry and are thus interchangeable at locations within the core and, because they are submerged in the pool of sodium coolant, they cannot be identified by visual inspection methods.

It would therefore be advantageous if the core assemblies could be held down without adding complexity, constraining an upper limit of the core, and could be identified without visual inspection techniques to ensure that the correct core assembly is positioned in the correct location and in the correct orientation within the core. These, and other advantages, will become apparent to those of skill in the art by reference to following description, figures, and claims.

### SUMMARY

According to some embodiments, a mechanical core assembly hold down system for a nuclear reactor includes a core assembly having an inlet nozzle, the inlet nozzle being generally cylindrical and having a sidewall; one or more ball locks carried by the inlet nozzle wherein at least a portion of the ball lock protrudes through the sidewall of the inlet nozzle; a receptacle positioned within a core of the nuclear reactor, the receptacle generally cylindrical and configured to accept the inlet nozzle of the core assembly; and a detent formed radially inwardly within the receptacle, the ball lock configured to fit within the detent when the nozzle is fully seated within the receptacle.

In some cases, the one or more detents comprise a pocket formed in the sidewall of the receptacle. Optionally, a biasing member is carried within the inlet nozzle and a driver wedge is biased in a driving direction by the biasing member. In some cases, the biasing member is a spring.

The driver wedge may include a first portion having a cylindrical cross section and a second portion having a tapered cross section. The driver wedge may be located adjacent the spring, and the spring is configured to apply a force to the driver wedge and wherein the ball lock is in physical contact with the tapered portion of the driver wedge and the driver wedge applies a radially outward force on the ball lock.

In some examples, a stepped bore is formed in the sidewall of the inlet nozzle, the stepped bore having a first portion that is sized to allow the ball lock to fit therein, and a second portion having a smaller diameter that the ball lock.

In some cases, the inlet nozzle comprises a plurality of ball locks, such as 2, 3, 4, 6, 8, or more and the number of ball locks can be used to vary the insertion and/or the removal force required.

In some embodiments, the detent comprises a circumferential groove formed in an inner surface of the receptacle. In some cases, the detent comprises a discrete detent configured to receive a ball lock.

The detent may include a lead-in angle upon which the ball lock impinges as the ball lock engages the detent.

The ball lock may be configured to engage the detent to provide a hold down force to the core assembly only upon a reduction in a hydraulic hold down force on the core assembly. That is, the ball lock may not experience any force unless the core assembly attempts to lift up at which point the ball lock engages the detent to inhibit withdrawal of the core assembly.

In some embodiments, the system is configured to require asymmetric forces for insertion and withdrawal of the inlet nozzle from the receptacle. For instance, the force required to withdraw the core assembly from the receptacle may be higher than the force required to insert the core assembly into the receptacle.

According to some embodiments, the mechanical hold-down system operates passively, requiring no external power or actuation to engage or disengage the hold-down mechanism.

In certain embodiments, the system provides a retention force that is between 1.5 and 4 times greater than the insertion force, and more preferably between 2.5 and 3.5 times greater than the insertion force.

According to some embodiments, the spring stack comprises nested wave springs including an inner wave spring 606 and an outer wave spring 608, wherein the nested configuration provides a combined spring constant selected to achieve desired insertion and retention forces.

In some embodiments, the receptacle comprises a liner installed within the receptacle 402, the liner being formed of a material selected to withstand the lifetime neutron fluence and temperature conditions of the reactor core.

According to certain embodiments, the system comprises between 2 and 8 ball locks 520 uniformly distributed around a circumference of the inlet nozzle 308, wherein the number of ball locks is selected based on required retention force.

In some embodiments, the stepped bore comprises a first diameter configured to receive the ball lock, and a second diameter configured to retain the ball lock within the nozzle.

According to some embodiments, the lead-in angle of the detent is between 30 and 60 degrees, and more preferably between 40 and 50 degrees, to optimize the balance between insertion force and retention force.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates, in a block diagram form, some of the basic components of a sodium-cooled fast reactor, in accordance with some embodiments.

FIG. 2 is a schematic sectional view of a core of a sodium-cooled fast reactor, in accordance with some embodiments.

FIG. 3 is an exploded view of a core assembly, in accordance with some embodiments.

FIG. 4 is an enlarged sectional view of an inlet nozzle and core support structure interface, in accordance with some embodiments.

FIG. 5 illustrates an inlet nozzle showing a ball detent mechanical holddown feature, in accordance with some embodiments.

FIG. 6 illustrates an exploded view of the components of the ball detent mechanical holddown system, in accordance with some embodiments.

FIG. 7 illustrates a close-up view of a ball detent mechanical holddown system, according to some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

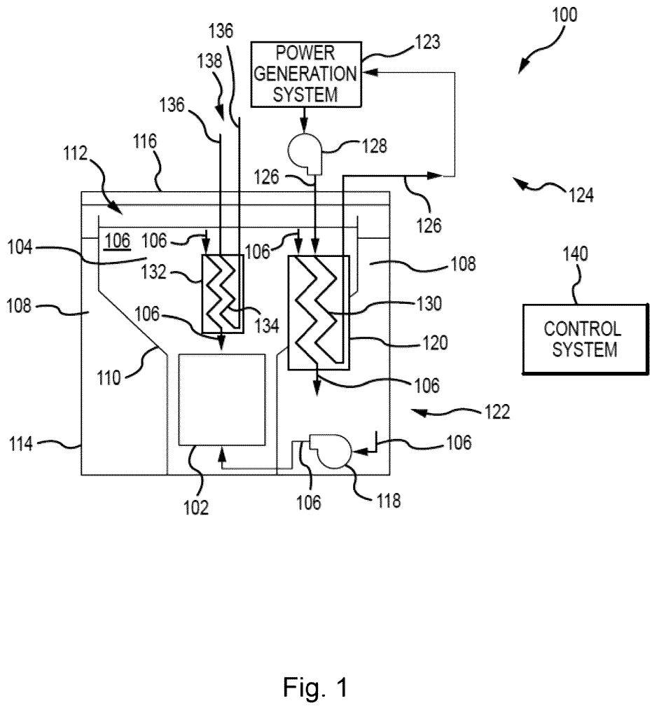

FIG. 1 illustrates, in a block diagram form, some of the basic components of a sodium-cooled fast reactor (SFR) fission plant 100. While an SFR may be used through the description as an example type of reactor technology, it should be appreciated that the concepts presented herein may be equally applicable to other types of reactors. In some cases, the concepts presented in the following description are directly appliable to other forms of sodium-cooled fast reactors (SFRs), such as, for example, traveling wave reactors, modular reactors, micro reactors, among others, and the disclosure and appended claims should not be limited to any specific nuclear reactor, fuel source, coolant type, or reactor architecture.

In general, the SFR fission plant 100 includes a reactor core 102 containing a plurality of core assemblies (not shown). The core 102 is disposed within a pool 104 holding a volume of liquid sodium coolant. The pool 104 nearer an upper portion of the reactor vessel is referred to as a hot pool and has a sodium temperature higher than that of a surrounding cold pool 108 that is nearer the lower portion of the reactor vessel (due to the energy generated by the fuel assemblies in the reactor core 102), which also contains liquid sodium coolant. The hot pool 104 is separated from the cold pool 108 by the redan 110. The sodium coolant flows through the reactor vessel along a flow path 106, both by natural circulation since the hotter sodium tends to rise and the colder sodium falls, as well as by a pump 118 that circulates the primary coolant. A headspace 112 above the level of the sodium coolant 106 is filled with an inert cover gas, such as argon. The reactor vessel 114 surrounds the reactor core 102, hot pool 104, and cold pool 108, and is sealed with a reactor head 116. The reactor head 116 provides various access points into the interior of the reactor vessel 114.

The size of the reactor core 102 is selected based on a number of factors, including the characteristics of the fuel, desired power generation, available reactor 100 space, and so on. Various examples of an SFR fission plant may be used in low power (around 300 MWe-around 500 MWe), medium power (around 500 MWe-around 1000 MWe), and high power (around 1000 MWe and above) applications, as required or desired. The performance of the reactor 100 may be improved by providing one or more reflectors, not shown, around the core 102 to reflect neutrons back into the core 102. Additionally, fertile and fissile nuclear assemblies may be moved (or “shuffled”) within and about the core 102 to control the nuclear reaction occurring therein.

The sodium coolant is circulated within the vessel 114 via a primary sodium coolant pump 118 along the primary coolant flow path 106. The primary coolant pump 118 draws sodium coolant from the cold pool 108 and injects it into a plenum below the reactor core 102. The coolant is forced upward through the core and is heated due to the fission reactions taking place within the reactor core 102. Heated coolant exits the upper end of the core 102 and enters an intermediate heat exchanger(s) 120 from the hot pool 104, and exits the intermediate heat exchanger 120 and re-enters the cold pool 108. This primary coolant loop 122 thus circulates sodium coolant entirely within the reactor vessel 114.

The intermediate heat exchanger 120 incorporates a segment of a closed liquid sodium loop that is physically separated from the primary sodium pools 104 and 108 at all times (i.e., intermediate and primary sodium are never co-mingled). The intermediate heat exchanger 120 transfers heat from the primary coolant loop 122 (fully contained within the vessel 114) to an intermediate coolant loop 124 (that is only partially located within the vessel 114). The intermediate heat exchanger 120 passes through the redan 110, thus bridging the hot pool 104 and the cold pool 108 (so as to allow flow of sodium in the primary coolant loop 122 therebetween). In an example, four intermediate heat exchangers 120 are distributed within the vessel 114. Alternatively, two or six intermediate heat exchangers 120 are distributed within the vessel 114, or some other number of heat exchangers 120 may be distributed about the reactor vessel 114.

The intermediate coolant loop 124 circulates sodium coolant 126 that passes through pipes into and out of the vessel 114, via the reactor head 116. An intermediate sodium pump 128 located outside of the reactor vessel 114 circulates the sodium coolant 126 to a power generation system 123. Heat is transferred from the sodium coolant 106 of the primary coolant loop 122 to the sodium coolant 126 of the intermediate coolant loop 124 in the intermediate heat exchanger 120. The sodium coolant 126 of the intermediate coolant loop 124 passes through a plurality of tubes 130 within the intermediate heat exchanger 120. These tubes 130 keep the sodium coolant 106 of the primary coolant loop 122 separate from the sodium coolant 126 of the intermediate coolant loop 124, while transferring heat energy therebetween.

A direct heat exchanger 132 extends into the hot pool 104 and provides cooling to the sodium coolant 106 within the primary coolant loop 122, usually in case of emergency. The direct heat exchanger 132 is configured to allow sodium coolant 106 to enter and exit the heat exchanger 132 from the hot pool 104. The direct heat exchanger 132 may have a similar construction to the intermediate heat exchanger 120, where tubes 134 keep separate the NaK (Sodium-Potassium) of the primary coolant loop 122 from the direct heat exchanger coolant (NaK) 136 of the direct reactor coolant loop 138, while transferring heat energy therebetween.

Other ancillary reactor components (both within and outside of the reactor vessel 114) include, but are not limited to, pumps, check valves, shutoff valves, flanges, drain tanks, etc., that are not depicted but would be apparent to a person of skill in the art. Additional penetrations through the reactor head 116 (e.g., a port for the primary coolant pump 118, inert cover gas and inspection ports, sodium processing, and cover gas ports, etc.) are not depicted. A control system 140 is utilized to control and monitor the various components and systems which make up the reactor 100.

Broadly speaking, this disclosure describes configurations that improve the performance of the reactor 100 described in FIG. 1. Specifically, examples, configurations, and arrangements of core assembly hold downs are utilized to inhibit liftoff of core assemblies. These features are shown and described in more detail below with reference to the following figures.

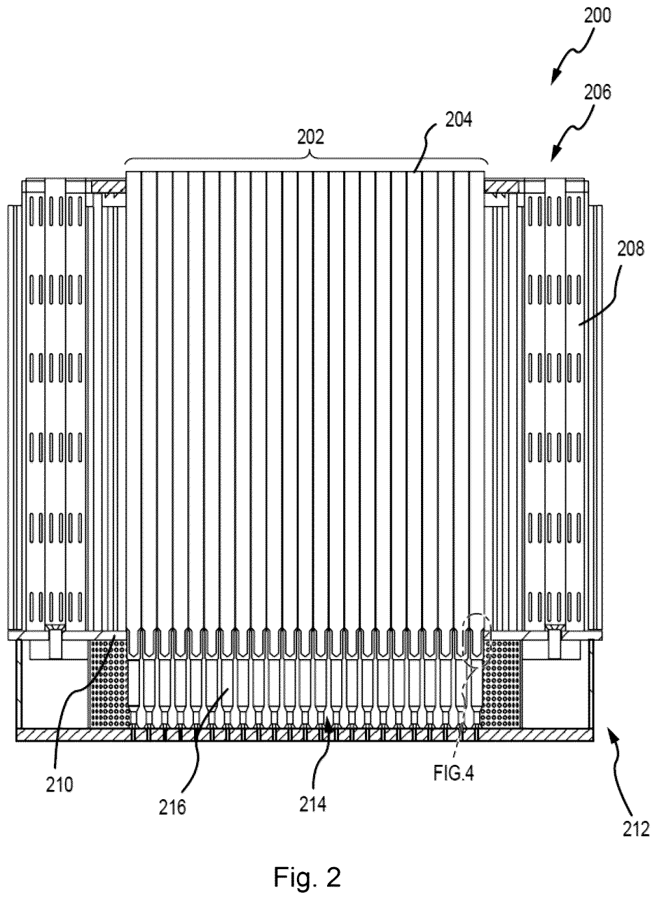

FIG. 2 is a schematic sectional view of a core 200 of an SFR. The core 200 is schematically shown and includes a central core region 202 having a plurality of core assemblies 204. The core assemblies 204 may include fissile nuclear fuel assemblies, fertile nuclear fuel assemblies, shield assemblies, reflector assemblies, control assemblies, standby shutdown assemblies, material testing assemblies, and other assembly types. In general, the contents of the assemblies (e.g., fissile material, control material, etc.) identifies the particular assembly. The components of the assemblies that hold such material may be identical, such as to facilitate shuffling the core assemblies around the core to any location, as desired. A peripheral core region 206 includes in-vessel storage pots 208. Throughout the life of the core 200, the fissile nuclear fuel assemblies and fertile nuclear fuel assemblies (as well as certain other assemblies) are shuffled between the central core region 202 and the peripheral core region 206. This is performed at various stages of the core life as required or desired to initiate, maintain, accelerate, control, or terminate nuclear reactions or power generation and/or for safety reasons.

The assemblies 204 are received by an upper plate 210 of a core support structure 212 at locations sized and configured to receive the core assemblies 204. Sodium coolant is pumped into a plenum 214 disposed below the upper plate 210 and flows upward into the core assemblies 204, where it is heated by the nuclear reactions taking place within the core 200. Structures that channel the flow of sodium through the core 202 and into the various assemblies are described below.

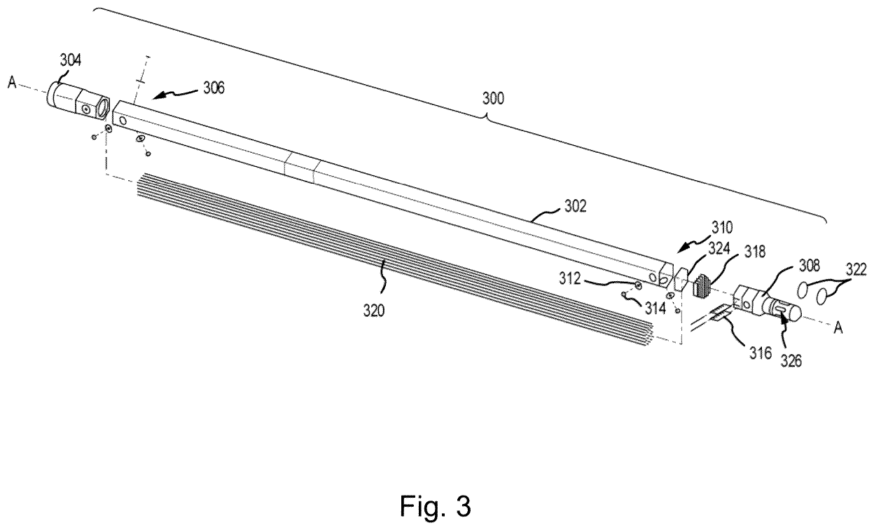

FIG. 3 is an exploded view of a core assembly 300. The assembly 300 includes an elongate duct 302 having an axis A. The duct 302 may have a hexagonal cross section. A handling socket 304 with an internal flow passage is secured to a first end 306 of the duct 302 and has internal or external features that allow it to be grasped by mechanisms within the reactor vessel to lift, lower, and otherwise move the assembly 300 into, out of, or within the core.

An inlet nozzle 308 is secured to a second end 310 of the duct 302. A plurality of bearing rings 312 and retaining rings 314 are used to attach the handling socket 304 and inlet nozzle 308 to the duct 302. A plurality of lock plates 316 (two in this example) and a plurality of pin strip rails 318 may be included proximate an end of the inlet nozzle 308. Together, the lock plates 316 and pin strip rails 318 connect the pin bundle 320 to the inlet nozzle 308. Seal rings 322 and a flow restrictor 324 may also be incorporated. The nozzle 308 defines a plurality of coolant inlet windows 326 that are in flow communication with an interior flow chamber (not shown) that extends through the nozzle 308. Thus, the windows 326 provide a path for sodium to flow into the nozzle 308 and into the duct 302 to flow around the pin bundle 320 disposed therein. Sodium flow continues out of the handling socket 304.

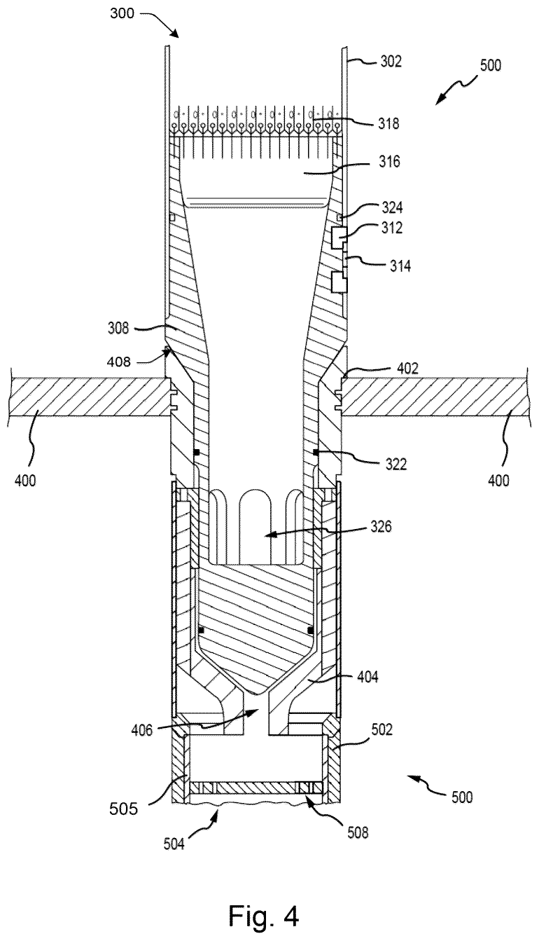

FIG. 4 is a sectional view of an example flow control system 500 showing the interface between an inlet nozzle 308 and core support structure 400. The inlet nozzle 308 is seated in and engaged with a receptacle 402 of the core support structure 400. A plurality of receptacles 402 may be located throughout the core and define locations for the core assemblies to be inserted. The nozzle 308 may have an oblique surface 408 that provides a funnel-shaped transition between a first diameter of the nozzle 308 and a second, larger diameter, of the duct 302. In some cases, the oblique surface 408 rests against the receptacle 402, while in other cases, the oblique surface 408 may be disposed above the receptacle 402. The interface between the oblique surface 408 and the receptacle 402 may be determined based upon the design of the receptacle and how far into the receptacle the core assemblies 300 are configured to be inserted. In some cases, there is a gap between the nozzle 308 and the receptacle 402 as will be described in further detail below.

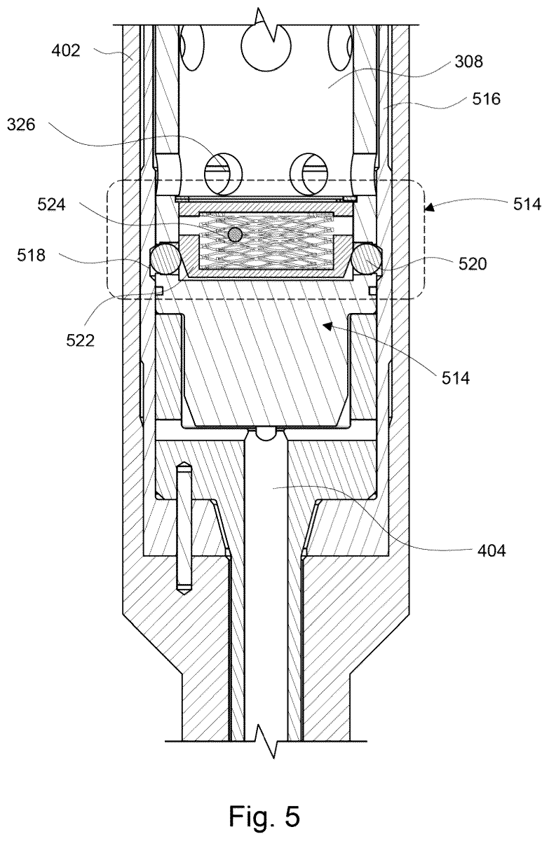

A base of the receptacle 402 includes a bypass tube 404 that defines a passage 406 that provides a flow path for sodium to pass through the core assembly 300 and exit through the handling socket to the reactor sodium hot pool. The receptacle 402 may extend above the core support structure 400, or may be even with an upper surface of the core support structure 400. Below the core support structure 400 is a coolant flow control system 500 that includes a masking element 502 and a flow stack 504 disposed therein. In some examples, the masking element 502 is in the form of a liner (516 of FIG. 5). The flow stack 504 may include an outer housing and at least one flow control assembly 508 disposed therein. The flow control system 500 is described in more detail below.

Suitable flow systems may utilize a standardized flow stack along with different masking liners (e.g., masking sleeves) at various locations below the core support structure. The terms liner and sleeve may be used interchangeably herein and refer to a portion of the receptacle that receives the inlet nozzle of the core assembly. The masking features may be secured to or integral with the core support structure while the flow stacks may be integral with a core assembly or discrete therefrom. By utilizing a standardized flow stack, manufacturing costs, inter-assembly differences, and risk of incorrect assembly are decreased because of the standardized parts. A masking sleeve allows each flow stack to be used in any core location, over a wide range of flow conditions such as those encountered in an SFR. The flow stack may be integral with a core assembly inlet nozzle or may be fixed within the masking sleeves. The flow stack may include multiple pressure stages and inlets for each stage. The masking sleeve may be disposed about the flow stack so as to create selective inlets to the flow stages. This arrangement allows for varying pressure drops according to the selective inlets exposed, which in turn dictates the number of pressure drop stages a flow will encounter. This allows for standardization of fuel assemblies while creating unique flow conditions for different core locations.

For an SFR, this may be advantageous as it allows a core assembly to be installed in, or relocated at any time to (e.g., shuffled to), a different core position while still receiving an appropriate metered flow rate (which can vary from location to location). In examples where the flow stacks are integral with the inlet nozzle, the flow stacks may be connected to a removable component (e.g., the core assembly). As such, lifetime effects (such as erosion damage) can be examined and mitigated as needed. For a “re-core” operation, where all core assemblies are exchanged for those of a different design, the replacement assemblies do not have to conform to the flow zones of the original core, allowing more flexibility in the design of future cores, if required or desired.

The materials selected for the ball-detent hold-down system 514 are preferably selected to withstand the harsh environment within the reactor core. The ball locks 520 are preferably formed from a precipitation-hardened stainless steel. The driver wedge 522 may be formed from 316 stainless steel with a surface treatment to minimize galling. The spring stack may be formed from Inconel X-750 or similar high-temperature, radiation-resistant alloy capable of maintaining spring properties at temperatures up to 550 °C.

FIG. 5 illustrates an inlet nozzle 308 and a mechanical hold down 514 for the core assembly, in accordance with some embodiments. As illustrated, the inlet nozzle 308 is inserted into a receptacle 402. The receptacle has a liner 516 into which the nozzle is inserted. In some cases, the sleeve is permanently installed within the receptacle 402 and is designed to last the lifetime of the nuclear reactor.

According to some embodiments, the nozzle 308 may have one or more annular grooves that provide a mounting location for bearing rings, retaining rings, flow restrictors, and/or seal rings. A plurality of coolant inlet windows 326 may be provided to allow coolant to flow to an interior of the inlet nozzle 308 and around the pin bundle that may be housed within the core assembly to which the nozzle 308 is attached.

The nozzle 308 may be formed to have a first end 505, which may be cylindrical in some cases. The first end 505 may be provided with a retaining structure 514 that may provide a mechanical interface with the receptacle. According to some embodiments, the retaining structure 514 is a ball detent feature that provides a mechanical interface between the nozzle 308 and the liner 516.

The liner may be formed with detents 518 that are configured to receive a protrusion extending from the nozzle 308, which may be ball locks 520. The ball locks 520 are encouraged outward by a driver wedge 522 and a spring 524.

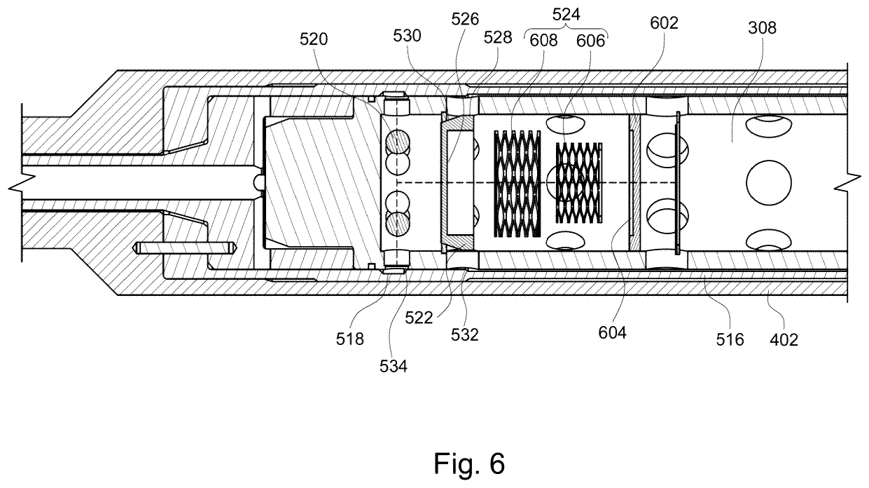

FIG. 6 illustrates an exploded view of the components that form the retaining structure 514, to help illustrate the various components and their relationship. A retention plate 602 provides a positive, immovable, stop against which the spring(s) 524 push against. The retention plate 602 may be formed of any suitable material, such as any of a number of stainless steels. The retention plate may include a retention plate pocket 604 formed therein to receive the spring(s) 524 and may be shaped as a circular pocket cut as a relief into the retention plate 602 to inhibit the spring(s) 524 from moving laterally. In some cases, the retention plate pocket 604 is sized to accommodate the largest diameter spring 524 in those cases that utilize a nested spring configuration. A spring stack 524 may include one, two, three, or more springs that may be nested. For example, in some cases, the spring stack 524 may include two wave springs with an inner wave spring 606 nested inside an outer wave spring 608. The spring stack 524 can be configured with a desired spring constant to vary the force of insertion and/or removal of the core assembly from the receptacle 402.

The spring stack 524 is supported by the retention plate 602 at an upper end and fits against the driver wedge 522 at a lower end. Similar to the retention plate 602, the driver wedge 522 may include a driver wedge pocket 526 to receive the spring stack 524 and to inhibit lateral movement of the spring stack 524. While the description refers to a spring stack 524 and shows both an inner wave spring 606 and an outer wave spring 608 that make up the spring stack 524, it should be readily apparent to those of skill in the art that other spring types and structures are contemplated herein and could be used in place of the illustrated spring stack 524. Therefore, the use of the term “spring stack” does not imply that a plurality of nested springs is the only way to provide the benefits described herein, but is used in an illustrative sense, and should be interpreted to include a single spring, multiple springs, and springs of different configurations (e.g., compression spring, straight coil springs, convex springs, concave springs, conical springs, variable rate springs, disc springs, die springs), among others.

The driver wedge 522 may have a varying cross section wherein a first portion of the outer surface of the driver wedge 522 is cylindrical 528 and a second portion of the outer surface of the driver wedge 522 is tapered, thus forming a tapered portion 530 having a range of diameters that are narrower than the cylindrical portion. The cylindrical portion 528 allows the driver wedge 522 to fit within the nozzle 308 with a small clearance such that the driver wedge 522 can slide axially within the nozzle 308. The tapered portion 530 of the driver wedge 522 provides an outward force on the ball locks 520 as it moves axially toward the ball locks to force the ball locks outward and into the detents 518 formed in the liner 516. While the description may refer to the detent being formed into the liner, it should be appreciated that the terms “liner” and “receptacle” may be used interchangeably as the liner is typically a component of the receptacle. Therefore, a reference to the detent being formed in the liner should be interpreted to mean that the detent may likewise be formed in the receptacle.

The liner 516 may be formed to have a ramp 532 that is an inclined surface that gradually narrows the inside diameter of the liner 516. The ramp 532, as the core assembly is inserted into the receptacle, causes the ball locks 520 to move radially inwardly during insertion, which in turn, forces the driver wedge 522 to move upwardly due to the interaction of the ball locks 520 against the tapered portion 530 of the driver wedge 522. This upward movement of the driver wedge 522 compresses the spring stack 524 against the retention plate 602. The spring stack 524 thus biases the driver wedge 522 to move downwardly and forces the ball locks 520 to move outwardly in response. Therefore, as the ball locks 520 become lined up with the detents 518, the ball locks are biased to move outwardly to be captured in the detents 518 formed in the liner. The length and shape of the ramp 532 has a direct impact on the required deformation of the spring stack 524 and therefore directly influences the insertion force required to fully seat a core assembly into a receptacle. The insertion force can therefore be tailored and can additionally provide force feedback to the in-vessel transfer machine which can be used as a secondary confirmation that the core assemblies are fully seated in the receptacles.

The detents 518 may each have a lead-in angle 534 that defines a draft angle of the sidewall of the detent 518. The lead-in angle 534 can be tailored to influence both the required insertion force and the lift off force required to insert and subsequently remove a core assembly. In some cases, the design of the retaining structure 514 can provide a retention force of about 500 lbs, while permitting an insertion force that is significantly lower, such as about 150 lbs. Consequently, the system can be configured such that the retention force is 1.5, or 2, or 2.5, or 3, or 3.5, or 4 or more times that of the required insertion force. By configuring the insertion force to be substantially less than the retaining force, this encourages a core assembly to reseat itself fully in the event of a seismic event that may unseat the core assembly.

The number of ball locks 520 and cooperating detents 518 are related to the required insertion and retention forces. Where additional retention force is desired, a number of different changes can be employed to affect the resulting retention force. For example, to increase the retention force, the number of ball locks 520 can be increased, the spring stack 524 can be selected to have a higher spring constant, the ramp 532 angle can be modified, the lead-in angle 534 of the detent can be modified, and other such geometric variations can be used to alter both the insertion force and/or the retention force.

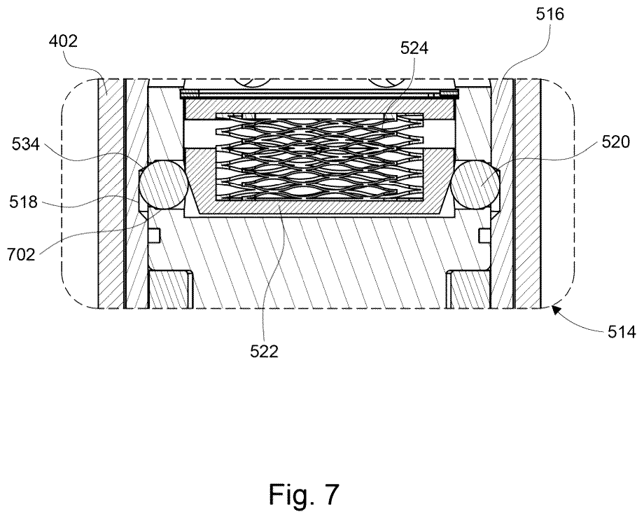

FIG. 7 illustrates a closeup cross-sectional view of the retaining structure 514, in accordance with some embodiments, where the core assembly is in a fully seated position. The liner 516 includes one or more detents 518. The detents may be formed as a circumferential groove formed into the inner surface of the liner 516 that extends all the way around the inner circumference or may extend partially around the inner circumference of the inner face of the liner 516. In some cases, the detents 518 may be discrete depressions, pockets, slots, or other relief features configured to receive a portion of the ball lock 520. The detents 518 may have a lead-in angle 534 formed into an upper sidewall of the detent 518.

The ball locks 520 may be held within a stepped bore 702 of the nozzle 308. The stepped bore 702 may have a first area having a first diameter that is sized to receive the ball lock 520 and a second area having a second diameter that is sized to be smaller than the diameter of the ball lock 520, thus inhibiting the ball lock from exiting the nozzle 308 entirely. Thus, the ball lock 520 can fit within the first area of the stepped bore 702 but is inhibited from passing through the second area of the stepped bore 702. The size of the stepped bore 702 also determines the maximum outward displacement of the ball locks 520.

In the fully seated position, ball locks 520 align with the detents 518 and snap outwardly into the detents 518 in response to the biasing member (e.g., the spring stack) and driver wedge applying a radially outward force on the ball locks 520. The ball locks 520 are biased outwardly due to the spring stack 524 applying a downward force on the driver wedge 522. The tapered portion of the driver wedge 522 imparts a radially outward force on the ball locks 520 to force them deeper into the stepped bore 702 and extend outwardly into the ball detents 518.

The ball-detent hold-down system 514 is designed to accommodate differential thermal expansion between components. During reactor operation, the inlet nozzle 308 and liner 516 may experience temperature differentials of up to 100 °C, resulting in differential radial expansion of the components. The stepped bore 702 may be sized to ensure that the ball locks 520 maintain sufficient engagement with the detents 518 throughout the expected range of thermal conditions. The spring stack 524 is preferably designed with sufficient travel to accommodate axial thermal growth while maintaining adequate preload on the driver wedge 522.

The asymmetric force profile of the hold-down system may be achieved through optimization of component geometries. In some embodiments, during insertion, the ball locks 520 contact the ramp 532 at a shallow angle of 15-20 degrees, requiring moderate force to compress the spring stack 524. The insertion force Fᵢ can be approximated by:

Fᵢ=n×k×d×tan(θᵣ)/tan(θ_{w})

where n is the number of ball locks, k is the spring constant, d is the radial displacement of the ball locks, θᵣ is the ramp angle, and θ_{w} is the wedge angle.

During withdrawal, the ball locks 520 engage the lead-in angle 534 of the detents at a steeper angle, such as 45 degrees in some examples, requiring substantially higher force. The retention force Fᵣ can be approximated by:

Fᵣ=n×k×d×tan(θ_{d})/tan(θ_{w})

where θ_{d} is the detent lead-in angle. By selecting θ_{d}>θᵣ, the system achieves Fᵣ>Fᵢ, typically with a ratio of 2.5-3.5.

As with all the embodiments herein, the number, pattern, and location of the ball locks 520 and detents 518 may be provided as desired. In some embodiments, there are two, or three, or four, or six, or eight, or more ball locks 520 and corresponding detents. As described above, the detents may be formed as a circumferential groove around the inner surface of the liner, and therefore any number of ball locks 520 can be used in any circumferential location to fit within the detent without having to manufacture a discrete detent to align with a ball lock 520. Therefore, a core assembly can be inserted in any rotational orientation and the ball locks 520 will align with the detent when the core assembly is fully seated within the receptacle.

The force required to insert or remove a nozzle from a receptacle may be tailored as desired. For instance, the travel distance of the ball lock may be lengthened or shorten to vary the contact force with the liner and detent. Similarly, the liner may have a ramp, and the detent may have a lead-in angle that increase the required insertion and retention forces. Furthermore, the ramp and lead-in angle may be configured such that a force required to insert the nozzle into the receptacle is less than a force required to remove the nozzle from the receptacle.

Furthermore, by controlling the force required to insert a nozzle into a socket, an in-vessel transfer machine within the nuclear vessel can determine when a nozzle is fully seated into a receptacle by measuring the force exerted on the core assembly as it is inserted into a receptacle.

During a seismic event, there may be vertical accelerations, and it can be detrimental if the core assembles jump up and down or even worse, if they become unseated from the receptacle. In many cases, the primary seating force of the core assemblies results from hydraulic hold down. As primary coolant flows into the inlet nozzle a pressure differential provides hydraulic hold down to maintain the core assembly in its fully seated position. However, there are scenarios in which hydraulic hold down may be reduced or lost. As the primary coolant mass flow bypasses the inlet nozzle and impinges upon the outside of the nozzle, it reduces the seating force and may create a lifting force that may unseat a core assembly. In some cases, a core restraint system (and other components) are provided to at least partially provide assembly hold down. The systems and methods described herein provide additional, and secondary, mechanical hold down. In some of the examples and embodiments described herein, the mechanical hold down remains passive and does not engage or provide any hold down force unless and until the hydraulic hold down force is reduced, and a core assembly begins to lift off. As a core assembly begins to lift from its receptacle, the mechanical hold down components described herein engage and provide additional hold down force to maintain the core assembly in its seated position within the receptacle. In other words, the ball lock is configured to engage the detent in the liner to provide a hold down force to the core assembly only upon a reduction in a hydraulic hold down force on the core assembly. This may happen, for example, where a seal (e.g., piston ring seal) between the nozzle and the receptacle fails and the primary coolant mass flow bypasses the nozzle. Where hydraulic hold down is sufficient to maintain the core assembly in the fully seated position within the receptacle, the mechanical hold down system may remain passive and may not provide any hold down force on the core assembly in some cases.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A mechanical core assembly hold down system for a nuclear reactor, comprising:
a core assembly having an inlet nozzle, the inlet nozzle being generally cylindrical and having a sidewall;
one or more ball locks carried by the inlet nozzle wherein at least a portion of each of the one or more ball locks protrudes through the sidewall of the inlet nozzle;
a receptacle positioned within a core of the nuclear reactor, the receptacle generally cylindrical and configured to accept the inlet nozzle of the core assembly; and
a detent formed radially inwardly within the receptacle, the ball lock configured to fit within the detent when the inlet nozzle is fully seated within the receptacle.

2. The mechanical core assembly hold down system of claim 1, wherein the one or more detents comprise a pocket formed in the sidewall of the receptacle.

3. The mechanical core assembly hold down system of claim 1, further comprising a spring carried within the inlet nozzle and a driver wedge biased in a driving direction by the spring.

4. The mechanical core assembly hold down system of claim 3, wherein the spring comprises an inner wave spring nested within an outer wave spring.

5. The mechanical core assembly hold down system of claim 3, wherein the driver wedge comprises a first portion having a cylindrical cross section and a tapered portion having a tapered cross section.

6. The mechanical core assembly hold down system of claim 5, wherein the driver wedge is located adjacent the spring and the spring is configured to apply a force to the driver wedge and wherein the ball lock is in physical contact with the tapered portion of the driver wedge and the driver wedge applies a radially outward force on the ball lock.

7. The mechanical core assembly hold down system of claim 1, further comprising a stepped bore formed in the sidewall of the inlet nozzle, the stepped bore having a first portion that is sized to allow the ball lock to fit therein, and a second portion having a smaller diameter than the ball lock.

8. The mechanical core assembly hold down system of claim 1, wherein the inlet nozzle comprises a plurality of ball locks.

9. The mechanical core assembly hold down system of claim 1, wherein the detent comprises a circumferential groove formed in an inner surface of the receptacle.

10. The mechanical core assembly hold down system of claim 1, wherein the detent comprises a discrete detent configured to receive a ball lock.

11. The mechanical core assembly hold down system of claim 1, wherein the detent comprises a lead-in angle upon which the ball lock impinges as the ball lock engages the detent.

12. The mechanical core assembly hold down system of claim 1, wherein the ball lock is configured to engage the detent to provide a hold down force to the core assembly only upon a reduction in a hydraulic hold down force on the core assembly.

13. The mechanical core assembly hold down system of claim 1, wherein the system is configured to require asymmetric forces for insertion and withdrawal of the inlet nozzle from the receptacle.

14. The mechanical core assembly hold down system of claim 13, wherein an insertion force of the inlet nozzle into the receptacle is less than a withdrawal force of the inlet nozzle from the receptacle.

15. The mechanical core assembly hold down system of claim 1, wherein the receptacle comprises a liner installed within the receptacle and formed of a material selected to withstand lifetime neutron fluence of the nuclear reactor.

16. The mechanical core assembly hold down system of claim 1, further comprising a retention plate coupled to the inlet nozzle and configured to provide a fixed reaction surface for a biasing member, the retention plate including a retention plate pocket sized to receive and laterally constrain the biasing member, the biasing member configured to exert a radially outward force onto the one or more ball locks.

17. The mechanical core assembly hold down system of claim 1, wherein the inlet nozzle comprises six ball locks uniformly distributed around a circumference of the inlet nozzle.

18. A method of securing a core assembly in a nuclear reactor, comprising:
inserting an inlet nozzle of the core assembly into a receptacle of a reactor core support structure;
contacting a ramp surface of the receptacle with one or more ball locks carried by the inlet nozzle;
compressing a spring within the inlet nozzle as the ball locks are forced radially inward by the ramp surface;
continuing insertion until the ball locks align with a detent in the receptacle; and
allowing the spring to bias a driver wedge against the ball locks to force the ball locks radially outward into the detent, thereby securing the core assembly within the receptacle.

19. The method of claim 18, further comprising:
measuring an insertion force required to insert the inlet nozzle into the receptacle using an in-vessel transfer machine;
comparing the measured insertion force to a predetermined threshold force; and
confirming full seating of the core assembly when the measured insertion force exceeds the predetermined threshold force, wherein the predetermined threshold force corresponds to the force required to compress the spring sufficiently for the ball locks to pass the ramp surface.

20. The method of claim 18, further comprising:
applying an upward withdrawal force to the core assembly;
engaging the ball locks with a lead-in angle of the detent as the inlet nozzle moves upward; and
maintaining engagement of the ball locks with the detent during a reduction in hydraulic hold-down force on the core assembly, thereby providing mechanical hold-down independent of coolant flow conditions.
